(19) United States
(12) Patent Application Publication
(10) Pub. No.: US 2023/0331461 A1
(43) Pub. Date: Oct. 19, 2023

(54) TABLET CASSETTE

(71) Applicant: TOSHO, INC., Tokyo (JP)

(72) Inventor: Yoshihito Omura, Tokyo (JP)

(21) Appl. No.: 18/044,649

(22) PCT Filed: Sep. 8, 2021
(86) PCT No.: PCT/JP2021/033014

§ 371 Date: Mar. 9, 2023

(30) Foreign Application Priority Data
Sep. 15, 2020 (JP) 2020-154940

(51) Int. Cl. B65D 83/04; A61J 7/00

(52) U.S. Cl. CPC B65D 83/0409; A61J 7/0076

(57) ABSTRACT

The rotor includes a core member rotating with a rotary shaft and a plurality of tablet receiving portions at an outer peripheral portion, and a body member including a fitting hole fitted to the core member. Retention mechanism is arranged in between the core member and the body member for determining a relative position between the core member and the body member and for retaining a fixed state between the core member and the body member. It is possible to use the rotor including various number of tablet receiving portions when the core member is a common part and the body member is replaceable. It is possible to avoid critical damage for members since a sphere as one or more engaging protrusion portions escape from one or more engaged hole portions and relative movement is caused between the core member and the body member, when the force applied to the core member exceeds a predetermined value.

### TECHNICAL FIELD

The present invention relates to a tablet cassette that constitutes a driven portion in a tablet feeder for automating dispensing of medicines performed in hospitals, pharmacies, etc.

### BACKGROUND ART

A conventional most used tablet feeder [for example, see FIGS. 1, 5, 8, etc. of Patent Document 1 (Japanese Patent Application Publication No. 2015-012893 (JPA 2015-012893))] comprised a drive portion fixed and mounted on a drawing shelf of a tablet packing apparatus or a main portion of a tablet splitting apparatus, etc., for power supply and control, and a tablet cassette removably mounted to the drive portion to facilitate tablet replenishment work etc. The conventional tablet cassette includes a tablet container having a tablet containing space therein for a plurality of tablets in a random manner, the tablet container including a bottom wall portion formed with a discharge port to allow the plurality of tablets in the tablet containing space to fall down one by one, a rotary shaft having an axial line extending in a direction orthogonal to the bottom wall portion of the tablet container, and a rotor operable to rotate about the axial line in the tablet containing space of the tablet container along with rotation of the rotary shaft, the rotor including a plurality of tablet receiving portions configured to receive the tablets one by one and allow the tablets to pass therethrough to the discharge port, the rotor including the plurality of tablet receiving portions configured being provided in the peripheral portion so as to be aligned in the rotation direction of the rotary shaft.

In addition, another conventional tablet cassette [Patent Document 2 (Japanese Patent Application Publication No. 2020-099585 (JPA 2020-099585))] comprises a core member rotating about an axial line, and a rotor having a body member having a plurality of tablet receiving portions at a peripheral portion thereof and a fitting hole being fitted on the core member. In the tablet cassette, the body member of the rotor is configured by a circumferential expansion-contraction mechanism and a radial expansion-contraction mechanism. The circumferential expansion-contraction mechanism can expand and contract in a circumferential direction by interlocking the plurality of tablet receiving portions, and the radial expansion-contraction mechanism can expand and contract in a radial direction by interlocking the plurality of tablet receiving portions. The rotor does not need to replace parts and has the tablet receiving portions of variable dimensions so that it can be used to sequentially discharge tablets of different sizes.

### RELATED-ART DOCUMENT

### Patent Document

Patent Document 1: Japanese Patent Application Publication No. 2015-012893
Patent Document 2: Japanese Patent Application Publication No. 2020-099585

### SUMMARY OF INVENTION

### Technical Problem

In the conventional tablet cassette disclosed in Patent Document 2, since the body member of the rotor is configured with the circumferential expansion-contraction mechanism and the radial expansion-contraction mechanism, there is a problem that it takes time to assemble and adjust the body member of the tablet cassette. Further, there is a problem that the attachment and detachment work cannot be performed with one touch, and the replacement work is not easy. Moreover, there is a problem that the number of the tablet receiving portions cannot be increased.

In addition, although rarely, emergency stop control may be performed in response to an increase in the electric current of the motor in the drive portion when the tablet is caught between the rotor and the partition unit in the tablet container and the rotation of the rotor is hindered. As a result, a fatal component damage can be avoided, it is, however, desirable to avoid permanent deformation of the member as much as possible considering stable operation and component life.

### Solution to Problem

The present invention provides a tablet cassette comprising a tablet container having a tablet containing space therein for containing a plurality of tablets in a random manner, the tablet container including a bottom wall portion formed with a discharge port to allow the plurality of tablets in the tablet containing space to fall down the plurality of tablets one by one, a rotary shaft having an axial line extending in a direction orthogonal to the bottom wall portion of the tablet container, and a rotor operable to rotate about the axial line in the tablet containing space of the tablet container along with rotation of the rotary shaft, the rotor including a plurality of tablet receiving portions configured to receive the tablets one by one and allow the tablets to pass therethrough to the discharge port, and the rotor including the plurality of tablet receiving portions configured being provided in the peripheral portion so as to be aligned in the direction of rotating of the rotary shaft. In the present invention, the rotor includes a core member rotating with the rotary shaft and the plurality of tablet receiving portions at an outer peripheral portion, and a body member including a fitting hole fitted to the core member. Retention mechanism is arranged in between the core member and the body member for determining a relative position between the core member and the body member and for retaining a fixed state between the core member and the body member. The retention mechanism comprises one or more engaged hole portions provided at one of the core member and the body member and the one or more engaging protrusion portions provided at the other of the core member and the body member, the engaged hole portion including an aperture extending in a radial direction orthogonal to an axial direction of the rotary shaft and opening toward the other of the core member and the body member, and the engaging protrusion portions extending in the radial direction orthogonal to the axial direction of the rotary shaft and projecting toward the one of the core member and the body member and a tip portion of the engaging protrusion portion entering into the engaged hole portions. Structure of the engaging protrusion or structure of the core member and the body member is so configured as to cause relative movement between the core member and the body member by the tip portions of the one or more engaging protrusion portions being contact state with the other of the core member and the body member when the tip portions of the one or more engaging protrusion portions do not enter into the one or more engaged hole portions provided at the other of the core member and the body member.

According to the present invention, by using the core member as a common component and replacing the body member, it becomes possible to use a plurality of types of rotors each having various numbers of tablet receiving portions. It is also possible to enter one or more engaging protrusion portions into one or more engaged hole portions reasonably and easily, since relative movement can occur between the core member and the body member until the one or more engaging protrusion portions enter into the one or more engaged hole portions. When replacing the body member, the one or more engaging projection portions are released from the one or more engaged hole portions by applying a predetermined rotational force to the core member or the body member or by applying a pulling force in the axial direction to the core member or the body member. Then, the body member and the core member can be easily separated by causing relative movement between the core member and the body member. Accordingly, it is finally possible to avoid critical damage for members since one or more engaging protrusion portions escape from one or more engaged hole portions and relative movement (idling) is caused between the core member and the body member, when the force applied to the core member exceeds a predetermined value in case of causing inhibition the rotation of the rotor due to stuck of the tablets between the rotor and the partition unit in the tablet container.

It is preferable that the shape and structure of the tip portions of the one or more engaging protrusion portions are configured to allow the one or more engaging protrusion portions to escape from the one or more engaged hole portions and allow the core member to rotate within the body member when the body member is restrained while the one or more engaging protrusion portions are fitted in the one or more engaged hole portions. In the case above, the engaging protrusion portion may include a rolling element, a biasing member operable to bias the rolling element so as to allow the displacement of the rolling element in the radial direction, and a containing structure containing the rolling element and the biasing member so as to expose a part of the rolling element. If the rolling element is used at the tip of the engaging protrusion portion, the tip of the engaging protrusion portion rotates, so that the core member or the body member can be reliably prevented from being scraped by the engaging protrusion portion. In the case above, the biasing member may have characteristics defined so as to allow the rolling element to escape from the engaged hole portion and to allow the core member to idle in the body member when the body member is restrained in a state where the part of rolling element is fitted in the engaged hole portion. If the rolling element is a sphere and the biasing member is an elastic element, the engaging protrusion portions can be manufactured at low cost using a ready-made rolling element and biasing member.

In the case that the one or more engaging protrusion portions are a plurality of engaging protrusion portions and the one or more engaged hole portions are a plurality of engaged hole portions, respectively, the plurality of engaging protrusion portions and the plurality of engaged hole portions are preferable provided equally spaced apart in the circumferential direction respectively. In this way, it is possible to reduce the time of fitting the plurality of engaging protrusion portions and the plurality of engaged hole portions after the body member is fitted into the core member.

The engaging protrusion portion is preferable to include a stopper portion which contacts a peripheral portion of the aperture of the engaged hole portion in a state in which the tip portion is fitted in the engaged hole portion provided at the other of the core member and the body member, the stopper portion is provided around a base portion of the tip portion. In this way, a stable engagement state can be obtained without any state that the engaging protrusion portion does not enter the engaged hole portion too much. This kind of the engaging protrusion portion is preferable to have somewhat deformable elasticity so as not to scrape a contact partner in a state in which the engaging protrusion portion is fitted in the engaged hole portion.

The tip portion of the engaging protrusion portion is preferable to have a curved surface which is convex toward the direction of protruding. In this structure, it is possible to suppress scraping of a part of the surface of the core member or the body member with which the engaging protrusion portion contacts until the engaging protrusion portion enters the engaged hole portion. As a result, it is possible to avoid unwanted scrapers and to extend the life of the engaging protrusion portion or the core member or the body member.

The one or more engaged hole portions are formed at portion of the body member where the tablet receiving portions are not formed. In this structure, it is possible to avoid that the mechanical strength of the body member is reduced.

The one or more engaged hole portions may be formed at portion of the body member where the tablet receiving portions are not formed, the engaged hole portion may be a through hole penetrating the body member in the radial direction. If the engaged hole portion is a through hole, verification after assembly is easier since the fitted state of the engaging protrusion portion can be checked from the outside of the body member through the through-hole.

An RFID tag having identification information used for confirming suitability of the body member may be mounted within the fitting hole of the body member. In this way, it is possible to confirm the reading of identification information after fitting the body member to the core member.

### BRIEF DESCRIPTION OF DRAWINGS

FIG. 1 is a vertical sectional view of a tablet cassette with an upper lid being removed according to a first embodiment of the present invention.

FIG. 1B is a perspective view illustrating the appearance of a rotor.

FIG. 1C is a perspective view illustrating the appearance of an engaging protrusion portion unit.

FIG. 1D is a side view of an engaging protrusion portion unit.

FIG. 2 is a developed perspective view of a rotor.

FIG. 3 is a perspective view relating to a core member and a body member just before fitting.

FIG. 4A is a horizontal sectional view relating to a core member and a body member in the fitted state and the circumferential direction relative position fixed state.

FIG. 4B is a horizontal sectional view relating to a core member and a body member in the circumferential direction relative position deviated state due to shaft rotation.

FIG. 5A is a vertical sectional view of an engaging protrusion portion unit.

FIG. 5B is a vertical sectional view of an engaging protrusion portion unit for another example.

FIG. 6A is a horizontal sectional view in opposite case of a placement relationship of an engaging protrusion portion unit and an engaged hole portion.

FIG. 6B is a horizontal sectional view in opposite case of a placement relationship of an engaging protrusion portion unit and an engaged hole portion.

FIG. 7A is a horizontal sectional view of a rotor of an embodiment used an engaging protrusion portion integrally formed.

FIG. 7B is a horizontal sectional view of a rotor of an embodiment used an engaging protrusion portion integrally formed.

FIG. 8 is a horizontal sectional view in opposite case of a placement relationship of an engaging protrusion portion and an engaged hole portion used an engaging protrusion portion integrally formed.

### DESCRIPTION OF EMBODIMENTS

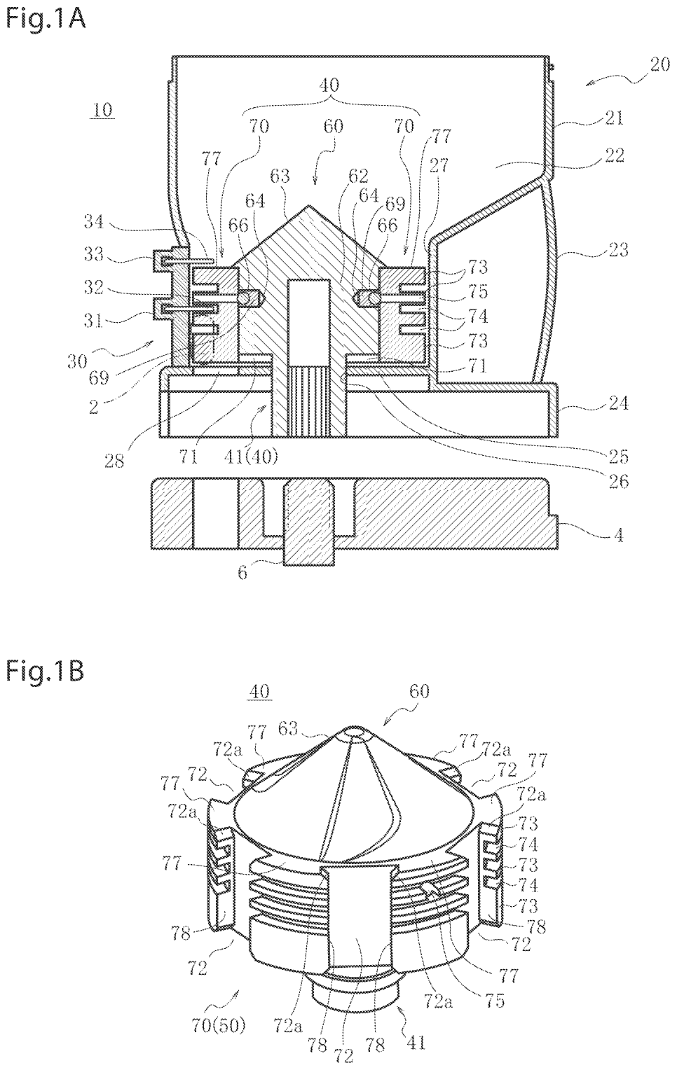

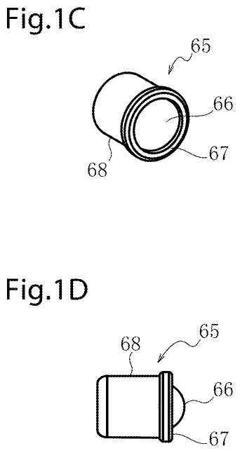

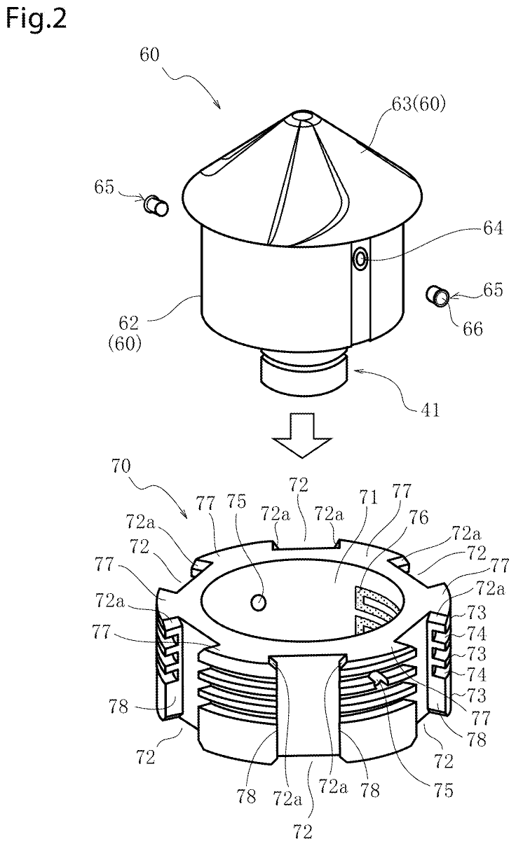

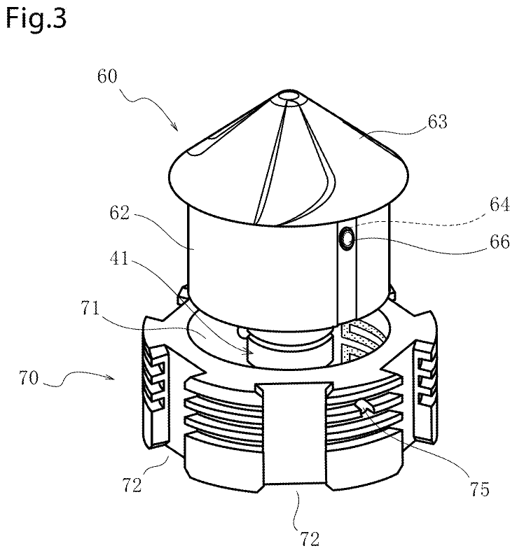

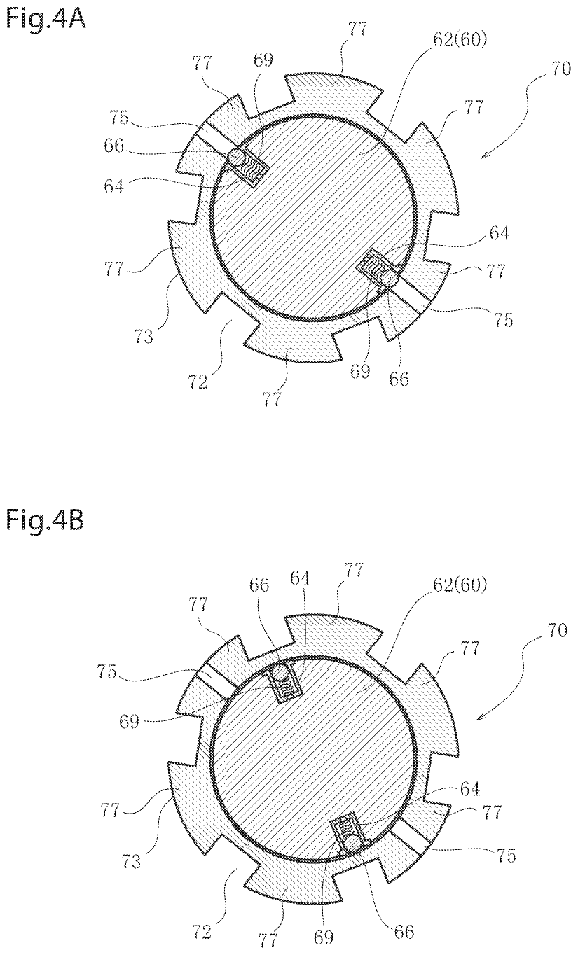

Tablet cassettes according to embodiments of the present invention will be described with reference to the drawings. FIGS. 1A through 4B are drawings for explaining the structure of first embodiment. FIG. 1A is a vertical sectional view of a tablet cassette 10 with an upper lid (not shown) being removed and a vertical sectional view of a driving portion 4. FIG. 1B is a perspective view illustrating the appearance of a rotor 40. FIG. 1C is a perspective view illustrating the appearance of an engaging protrusion portion unit 65 including an engaging protrusion portion described below. FIG. 1D is a side view of an engaging protrusion portion unit 65. FIG. 2 is a perspective view illustrating the appearance of a core member 60 and a body member 70 before fitting. FIG. 3 is a perspective view illustrating the appearance of a core member 60 and a body member 70 just before fitting when reducing axial relative distance. FIG. 4A is a horizontal sectional view illustrating the appearance of a rotor 40 when retention mechanism is in an engaged state in case that a core member 60 and a body member 70 are in the fitted state. FIG. 4B is a horizontal sectional view illustrating the appearance of a rotor 40 when retention mechanism is in a disengaged state in case that a core member 60 and a body member 70 are in the fitted state.

Before using, a tablet container 20 commonly used for a plurality of tablets 2 of various shapes and the core member 60, and some body members 70 replaced according to the difference in shape of the plurality of tablets 2 are prepared for the tablet cassette 10. Then, the presence or absence of the body member 70 corresponding to the plurality of tablets 2 are checked when the plurality of tablets 2 to be handled have been decided based on prescriptions and dispensing instructions, but there are no available tablet cassettes that can be used immediately. At that time, it is required to look for any tablet cassette not only by visual observation, but also by reading a later-described RFID tag 76 attached to the body member 70 with a reader and collating it with the database. The necessary tablet cassette 10 can be easily and quickly assembled and used by combining with the common parts (60, 41, 20) if the usable body member 70 is found.

As illustrated in FIG. 1A, the tablet cassette 10 of the present embodiment includes the tablet container 20, a partition unit 30 and the rotor 40. The tablet container 20 includes the tablet containing space 22 for randomly housing a large number of tablets in a container body 21 and a discharge port 28 at a bottom wall portion 25 of the container body 21, the discharge port 28 at the bottom wall portion 25 of the container body 21. The discharge port 28 is operable to discharge the tablets in the tablet containing space 22. A through hole 26 where the rotary transmission shaft 41 penetrates is formed at the bottom wall portion 25. The tablet container 20 includes a grip 23 and a mount-unmount portion 24, same as conventional products. In addition, the partition unit 30 includes partition retaining portions 31, 33 provided outside of the tablet container 20. The partition retaining portions 31, 33 are provided with partitioning portions 32, 34 which are inserted into the container body 21 to prevent over-ejection of tablets.

The rotor 40 includes a body member 70 and a core member 60 fitted in the body member 70, the body member 70 forming a plurality of tablet receiving portions 72 by being received in the tablet container 20 in an axially rotatable state. On the other words, the rotor 40 includes the core member 60 rotating with a rotary shaft 6 and the body member 70 having the plurality of tablet receiving portions 72 on an outer peripheral portion and a fitting hole 71 fitted to the core member 60. Further, the rotor 40 includes the rotary transmission shaft 41 whose lower end protrudes outside the tablet container 20 and transmits the rotary force from the rotary shaft 6. As explained in detail below, the rotor 40 used in the present embodiment includes a retention mechanism (65, 75) in addition to the fitting configuration between the core member 60 and the body member 70.

Each part will be described in detail below. The tablet container 20 (referenced in FIG. 1A) is mainly composed of the box-shaped container body 21 mass-produced by plastic injection molding. Inner space of the container body 21 is the tablet containing space 22 which is capable to contain the plurality of tablets at random, and the tablet containing space 22 is opened and closed by an upper lid not shown in any Figures when replenishing the plurality of tablets, etc. The grip 23 for carrying is provided at an outer side of the tablet container 21. Further, a lower portion of the container body 21 serves as the mount-unmount portion 24 for the driving portion 4. It is noted that the part shown as the driving portion 4 in FIG. 1A is an upper end portion of a base to which the tablet cassette 10 is attached and detached and is not included in the tablet cassette 10.

Further, the discharge port 28 is formed in a penetrating state at one place (left side in FIG. 1A) of the bottom wall portion 25 of the container body 21 in the tablet container 20. The tablet 2 falls downward through the discharge port 28 when the tablet 2 is conveyed above the discharge port 28 by rotating of the rotor 40.

Furthermore, the container body 21 of the tablet container 20 is configured such that the partition unit 30 can be attached and detached. In addition, the partition retaining portion 31 of the partition unit 30 is attached to the container body 21 from the outside and the partitioning portion 32 is inserted into the tablet containing space 22 through a slit of the container body 21. With such the partitioning portion 32 is positioned above the discharge port 28, the tablet below the partitioning portion 32 drops, but the tablets above the partitioning portion 32 are prevented from dropping. As a result, the tablets fall one by one.

In addition to the above, the belt holding portion 33 of the partition unit 30 can be also attached to or detached from the container body 21 from the outside of the container body. The belt holding portion 33 holds, for example, the stretchable endless belt 34 made of rubber in the shape of a round cord in a stretched state. The endless belt 34 is positioned above the discharge port 28 and the partitioning portion 32 when the partition unit 30 is attached to the container body 21 and the endless belt 34 is inserted into the tablet containing space 22 through the slit of the container body 21. In the structure described above, the partitioning portion 32 may be made of rubber like the endless belt 34, or may be made of a metal plate. Further, the partition holding portion 31 and the belt holding portion 33 are also mostly made of plastic, but they may be made of other materials such as metal.

The rotor 40 includes the body member 70 defining the plurality of tablet receiving portions 72 (six in the present embodiment) at an inner bottom of the tablet containing space 22 by being received in the tablet container 20 in an axially rotatable state and the core member 60 integrally provided with the rotary transmission shaft 41 which is fitted with the rotary shaft 6 of the driving portion 4 and is rotationally driven by the rotary shaft 6. The rotor 40 transports the tablet 2 that has fallen into any one of the tablet receiving portions 72 to the discharge port 28 together with the tablet receiving portions 72 during rotation and makes the tablet drop and discharge from the discharge port 28. The rotor 40 is mostly made of plastic.

In particular, the rotor 40 used in the present embodiment differs from the structure of conventional products in the structure in which the core member 60 including the rotary transmission shaft 41 and the body member 70 having the fitting hole 71 penetrating through which the core member 60 can be fitted and the body member 70 having the plurality of tablet receiving portions 72 formed at an equal pitch on an outer peripheral portion are combined. By using the rotor 40, it is possible easily to change the number of the tablet receiving portions 72 by using the core member 60 as a common part and replacing the body member 70 combined with the core member 60. In addition, six barrier walls 77 extending to an outer side in a radial direction are formed integrally at regular intervals in the body member 70 of the rotor 40. Six tablet receiving portions 72 are formed between two barrier walls 77 adjacent in the circumferential direction. Further, a tapered portion 72a is formed respectively in two side walls 78 of two barrier walls 77 located on both sides in the circumferential direction of the upper ends of the six tablet receiving portions 72 facing each other in the circumferential direction. The two tapered portions 72a are formed so as to allow that even a plurality of long tablets 2 such as an elliptical shape can be smoothly slid into the tablet receiving portions 72. The two tapered portions 72a facing each other in the circumferential direction are inclined such that the interval between the two tapered portions 72a increases upward. In the rotor 40 used in the present embodiment, the rotary transmission shaft 41 is formed integrally into the core member 60, but the core member 60 may be an assembly in which the rotary transmission shaft 41 is constructed separately.

As illustrated in FIG. 1A, the core member 60 includes an insert portion 62 having a generally columnar or cylindrical shape and having an outer diameter slightly smaller than an inner diameter of the fitting hole 71 and an umbrella portion 63 integrally formed on the insert portion 62. The umbrella portion 63 is generally conical shape, has shallow grooves for stirring the tablets carved on the inclined surface of the upper surface and a lower end of the umbrella portion 63 is integrated with an upper end of the insert portion 62. Then, as illustrated in FIGS. 1A, C and D, and FIG. 2 through FIG. 4, two engaging protrusion portion units 65 are arranged at two positions where the outer peripheral surface of the insert portion 62 is divided at equal intervals (180 degrees intervals) on the core member 60. Two fitting holes 64 into which the two engaging protrusion portion units 65 are fitted are formed at intervals of 180 degrees in the circumferential direction on the core member 60.

The specific body member 70 (see FIGS. 1, 2) is formed by processing a resin cylindrical body and the inner diameter of the fitting hole 71 passing through the center of the cylindrical body is slightly larger than the outer diameter of the insert portion 62 of the core member 60 described above. The plurality of (six in FIGS. 1, 2) tablet receiving portions 72 extending in the axial direction are formed at the outer peripheral portion of the body member 70. The shape of the tablet receiving portion 72 is such that only one tablet 2 to be handled can enter in the vertical direction. Three slits 74 extending in the circumferential direction are formed by engraving from an outer peripheral surface 73 in the six barrier walls 77 located between the adjacent two tablet receiving portions 72 on the outer peripheral portion of the body member 70. The three slits 74 are for avoiding interference with the partitioning portion 32 of the partition unit 30 and are spaced apart in the axial direction (vertical direction) so that the height of the mounting position of the partitioning portion 32 can be changed. Further, the barrier wall 77 has higher strength and rigidity than the portion where the tablet receiving portion 72 is formed and the engaged hole portion 75 extending from the outer peripheral surface 73 to the fitting hole 71 is formed on the barrier wall 77.

Note that, if three fitting holes 64 receiving the above-referenced engaging protrusion portion unit 65 are arranged at intervals of 120 degrees in the circumferential direction, the three engaged hole portions 75 are also arranged at intervals of 120 degrees in the circumferential direction. In case that there are the four engaging protrusion portion units 65, the four engaged hole portions 75 are arranged at intervals of 90 degrees in the circumferential direction.

Furthermore, the RFID tag 76 is attached at the fitting hole 71 of the body member 70 (see FIG. 2). A commercially available thin flexible RFID tag (Radio Frequency Identifier) is adopted and identification information assigned to the body member 70 respectively is written in advance and stored as data for the RFID tag 76. The identification information, which is used for the confirming suitability of the body member 70, can be read by wireless communication. Therefore, the confirming suitability of the body member 70 can be checked not only when the core member 60 and the body member 70 are separated, but also after the core member 60 and the body member 70 are fitted and integrated.

In the state illustrated in FIG. 1A and FIG. 4A, tip portions (parts of the spheres 66) of the two engaging protrusion portion units 65 are in the state of entering the two engaged hole portions 75 since the body member 70 is fitted to the core member 60. In this state, the relative positional relationship between the core member 60 and the body member 70 is fixed. Accordingly, the retention mechanism is provided to establish the relative position between the core member 60 and the body member 70 and to maintain the fixed state of the core member 60 and the body member 70 by two engaging protrusion portion units 65 and two engaged hole portions 75.

The specific engaging protrusion portion unit 65 comprises the sphere 66 as a rolling element that constitutes the engaging protrusion portion and an elastic element 69 as a biasing member that biases the sphere 66 to allow radial displacement of the sphere 66. Then, the elastic element 69 and the sphere 66 are contained in a bottomed cylindrical case 68 as a containment structure so as to expose a part of the sphere 66. In this embodiment, the sphere 66 has a smaller diameter than the diameter of the inner space of the case 68 so that the sphere 66 can easily move radially inside the case 68. In addition, the elastic element 69 as a biasing member that exerts a force to press the sphere 66 against the through hole of a peripheral portion 67 of the case 68 is constructed by incorporating an elastic member made of rubber, sponge, coil spring, or the like into the inside of the case 68 in an appropriately compressed state. If the sphere 66 is used as the rolling element, the sphere 66 rotates, so that the core member 60 or the body member 70 can be reliably prevented from being scraped by the sphere 66. In this case, the elastic element 69 as a biasing member has characteristics determined to allow the core member 60 to idle within the body member 70 since the elastic element 69 escapes from the engaged hole portion 75 when the body member 70 is in a restricted state with a part of the sphere 66 fitted in the engaged hole portion 75. Of course, instead of the sphere 66, a cylindrical roller may be used as the rolling element.

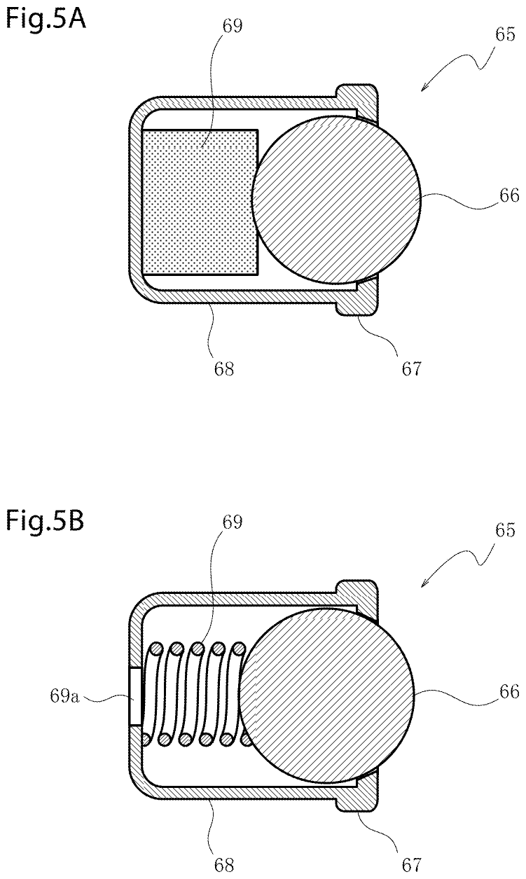

FIG. 5B shows an example in which a coil spring is used as the elastic element 69 as the biasing member of the engaging protrusion portion unit 65. In this embodiment, an air vent 69a is formed in the bottom of the case 68 so that the sphere 66 can move smoothly. In either type of engaging protrusion portion unit 65 illustrated in FIGS. 5A and 5B, when a pushing force is applied to the sphere 66, the sphere 66 retreats from the peripheral portion 67 into the hollow of the case 68.

In the rotor 40 incorporating such an engaging protrusion portion unit 65, the core member 60 and the body member 70 are fixed in both the axial direction and the circumferential direction to be in an integrated state so that the tablet cassette 10 can perform tablet sequential discharge operation since the sphere 66 of the engaging protrusion portion unit 65 moves radially, the sphere 66 protrudes from the peripheral portion 67 and enters one end portion of the engaged hole portion 75 when the core member 60 is fitted into the body member 70 and the sphere 66 of the engaging protrusion portion unit 65 and the engaged hole portion 75 are aligned,

In addition, a mechanical retention mechanism comprising the sphere 66 and the engaged hole portion 75 also helps prevent breakage when the body member 70 becomes undesirably locked with respect to the tablet container 20 during such tablet sequential discharge operation described above. In the specific explanation, if the core member 60 is forcibly rotated in a situation where the body member 70 is locked and cannot be easily rotated, the sphere 66 is pushed in and the elastic element 69 as the biasing member is contracted, the sphere 66 moves inside the case 68, the sphere 66 slips out of the engaged hole portion 75, the engagement between the body member 70 and the core member 60 is released, and the core member 60 idles. In this way, only slight deformation of the body member 70 is required because the sphere of the engaging protrusion portion unit 65 is actively displaced.

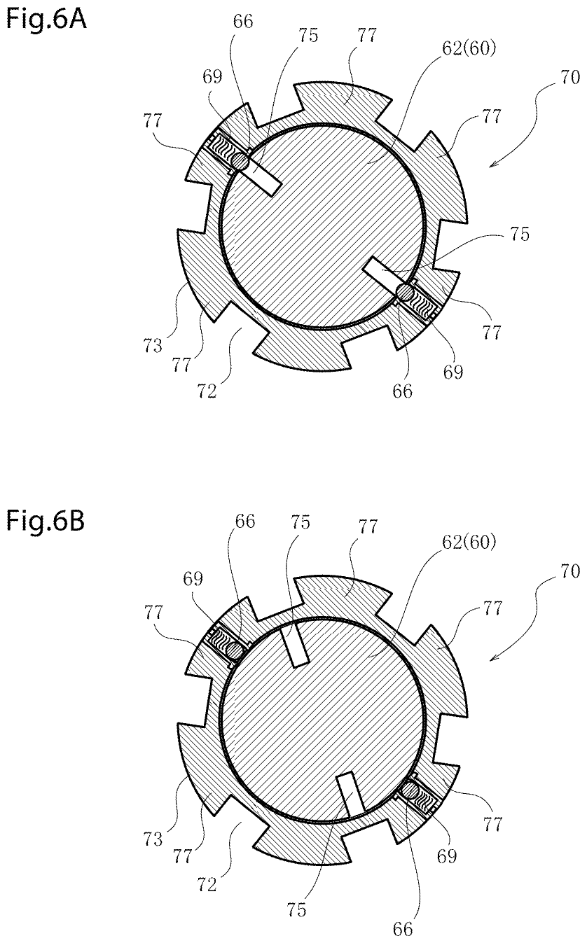

In the above-explained embodiments, although the engaging protrusion portion unit 65 is provided at the core member 60 side and the engaged hole portion 75 is provided at the body member 70 side, it goes without saying that the engaging protrusion portion unit 65 may be provided at the body member 70 side and the engaged hole portion 75 may be provided at the core member 60 side as illustrated in FIGS. 6A and 6B.

How to use the tablet cassette 10 is the same as that in the art. When the rotary shaft 6 rotates according to a command from a control device (not illustrated in Figs.), the rotor 40 also rotates and then the plurality of tablets 2 placed on the umbrella portion 63 and the body member 70 fall into the tablet receiving portion 72 and are transferred one after another onto the discharge port 28. Then, sequential discharge of the plurality of tablets 2 is appropriately performed according to the amount of rotation of the rotary shaft 6 since only the tablet 2 under the partition holding portion 31 drops downward from the discharge port 28. Conventionally, damage to the body member 70 is prevented by an excessive increase in the drive current associated with rotation control of the rotary shaft 6 and control to stop the rotation drive in accordance with the detection thereof due to interference with the partition holding portion 31 of the partition unit 30 and an inner peripheral surface 27 of the tablet container 20, or the fragments and scraps of the plurality of tablets 2 being mixed, etc. during tablet sequential discharge operation. However, in the tablet cassette 10 of the present embodiment, damage or the like is also prevented by the mechanical retention mechanism comprising the spheres 66 and the engaged hole portions 75 as the engaging protrusion portions of the engaging protrusion portion units 65.

According to the present embodiment, by using the core member 60 as a common component and replacing the body member 70, it becomes possible to use a plurality of types of rotors 40 each having various numbers of tablet receiving portions 72. It is also possible to enter the spheres 66 as the engaging protrusion portion into the engaged hole portions 75 reasonably and easily, since it can be caused relative movement between the core member 60 and the body member 70 until the spheres 66 as the engaging protrusion portion are entered into the engaged hole portions 75. When replacing the body member 70, the spheres 66 are released from the engaged hole portions 75 by applying a predetermined rotational force to the core member 60 or the body member 70 or by applying a pulling force in the axial direction to the core member 60 or the body member 70. Then, the body member 70 and the core member 60 can be easily separated by causing relative movement between the core member 60 and the body member 70. Accordingly, it is finally possible to avoid critical damage for members since the sphere 66 as the engaging protrusion portion escape from the engaged hole portion and relative movement (idling) is caused between the core member 60 and the body member 70, when the force applied to the core member 60 exceeds a predetermined value in case of causing inhibition the rotation of the rotor 40 due to stuck of the tablets between the rotor 40 and the partition unit 30 in the tablet container 20.

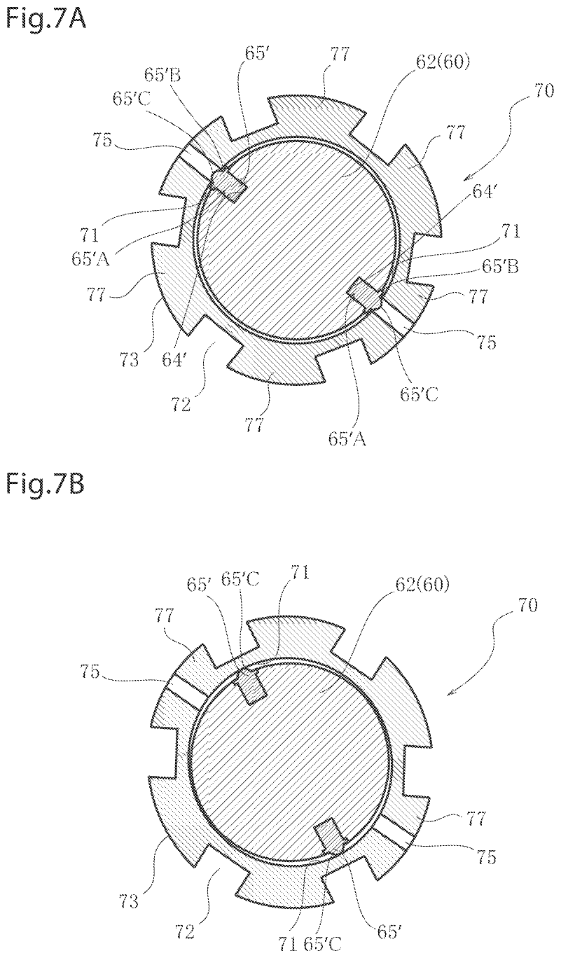

FIGS. 7A and 7B are drawings for explaining an embodiment in which an integrally formed engaging projection portions 65′ are used. The engaging protrusion portion 65′ includes a short body portion 65′A having a round bar shape or a cylindrical shape, a flange shaped peripheral portion 65′B slightly enlarged in diameter at one end thereof and a tip portion 65′C that rises from the central portion and protrudes from the central portion. The engaging protrusion portion 65′ is adapted to be attached into the inserting portion 62 of the core member 60 with the tip portion 65′C protruding from the inserting portion 62 in the outer diameter direction by lightly press-fitting the body portion 65′A into the fitted hole 64′, since the diameter of the body portion 65′A is the same as or slightly larger than the diameter of the fitted hole 64′, and the diameter of the peripheral portion 65′B is larger than the diameter of the fitted hole 64′.

Such engaging protrusion portion 65′ may be made by forming a thin round bar by cutting or the like. The material of the engaging protrusion portion 65′ may be plastic or metal, but the tip portion 65′C is preferably harder than the body member 70.

In addition, the surface of the tip portion 65′C of the engaging protrusion 65′ is a smooth convex surface that is a spherical surface or a nearly spherical surface and the size of the tip portion 65′C is such that it can fit into the engaged hole portion 75 of the body member 70 described above. On the other hand, the peripheral portion 65′B around the tip portion 65′C is enlarged in diameter so that it cannot enter into the engaged hole portion 75.

A detailed explanation of the assembly of this embodiment is as follows. Firstly, the inserting portion 62 of the common core member 60 is inserted into the fitted hole 71 of the body member 70 selected for tablets 2. Secondly, when the tip portion 65′C of the engaging protrusion portion 65′ comes into contact with the upper end of the body member 70, the body member 70 is further pushed. Then (see FIG. 7B), the body member 70 is slightly deformed by being pushed by the tip portion 65′C of the engaging protrusion portion 65′, and the fitted hole 71 becomes oval, into which the engaging protrusion portions 65′ slide.

After the situation above (see FIG. 7A), the peripheral portion 65′B of the engaging protrusion portion 65′ contacts the inner peripheral surface of the fitted hole 71 at the same time when the tip portion 65′C of the engaging protrusion portion 65′ fits into one end of the engaged hole portion 75 when the core member 60 is further pushed while aligning so that the engaging protrusion portion 65′ faces the engaged hole portion 75 of the body member 70. Then, the deformation of the body member 70 is released and the fitted hole 71 returns to a circular shape, furthermore, the core member 60 and the body member 70 are fixed in both the axial direction and the circumferential direction to form an integrated state, and finally, the rotor 40 that can be used for the tablets 2 to be handled is completed (see FIG. 7A).

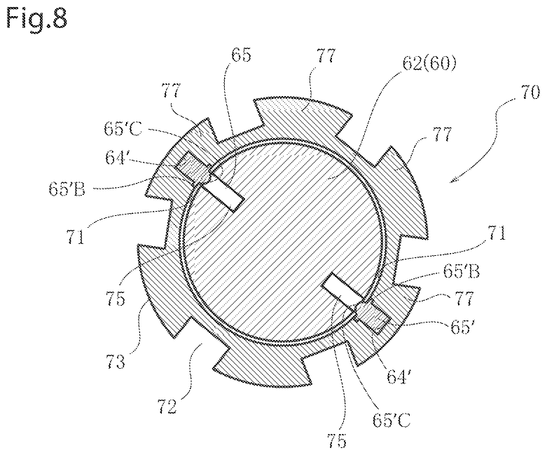

In the embodiments described above, although the engaging protrusion portion 65′ is provided on the core member 60 side and the engaged hole portion 75 is provided on the body member 70 side, it goes without saying that the engaging protrusion portion 65′ may be provided on the body member 70 side and the engaged hole portion 75 may be provided on the core member 60 side as illustrated in FIG. 8.

The engaging protrusion portion 65′ preferably has elasticity to some extent so as to prevent the contact partner from being scraped while the tip portion thereof is not in the engaged hole portion 75.

### [Others]

Although the above-described explanation omitted referring in detail in order to avoid complication, the rotor 40 may be pushed up intermittently, specifically each time the abutment member gets over the thrust member with the rotation around the axial line of the rotor 40 (see Japanese Patent Application Publication No. 2019-141330, for example), when a small number of thrust members, for example, about two, are attached to the upper surface of the bottom wall portion 25 of the tablet container 20 (not illustrated in Figs.) at the same time when a small number of downward contact members, for example, about two, are attached to the outer periphery of the upper end of the rotary transmission shaft 41 and the outer periphery of the lower end of the core member 60 about the rotor 40 (not illustrated in Figs.).

By doing so, even if the plurality of tablets are clumped together, the clumps can be broken up quickly, and the individual tablet can easily roll down into the tablet receiving portion 72.

### INDUSTRIAL APPLICABILITY

According to the present invention, by using the core member as a common component and replacing the body member, it becomes possible to use a plurality of types of rotors each having various numbers of tablet receiving portions. It is also possible to enter one or more engaging protrusion portions into one or more engaged hole portions reasonably and easily since it can be caused relative movement between the core member and the body member until the one or more engaging protrusion portions are entered into the one or more engaged hole portions. When replacing the body member, the one or more engaging projection portions are released from the one or more engaged hole portions by applying a predetermined rotational force to the core member or the body member or by applying a pulling force in the axial direction to the core member or the body member. Then, the body member and the core member can be easily separated by causing relative movement between the core member and the body member. Accordingly, it is finally possible to avoid critical damage for members since one or more engaging protrusion portions escape from one or more engaged hole portions and idling is caused between the core member and the body member, when the force applied to the core member exceeds a predetermined value in case of causing inhibition the rotation of the rotor.

### DESCRIPTION OF REFERENCE NUMERALS

2 tablet
4 driving portion (base)
6 rotary shaft
10 tablet cassette
20 tablet container
21 container body
22 tablet containing space
23 grip
24 mount-unmount portion
25 bottom wall portion
26 through hole
27 inner peripheral surface (alignment board interpolation space)
28 discharge port
30 partition unit
31 partition holding portion (belt holding portion)
32 partitioning portion (endless belt)
33 belt holding portion
34 endless belt
40 rotor
41 rotary transmission shaft
60 core member
62 inserting portion
63 umbrella portion
64 fitted hole
65 engaging protrusion portion unit (retention mechanism)
65′ engaging protrusion portion
66 sphere
67 peripheral portion
68 case
69 elastic element
69a air vent
70 body member
71 fitting hole
72 tablet receiving portion
72a tapered portion
73 outer peripheral surface
74 slit
75 engaged hole portion (retention mechanism) and
76 RFID tag

1. A tablet cassette comprising:
a tablet container having a tablet containing space therein for containing a plurality of tablets in a random manner, the tablet container including a bottom wall portion formed with a discharge port to allow the plurality of tablets in the tablet containing space to fall down the plurality of tablets one by one;
a rotary shaft having an axial line extending in a direction orthogonal to the bottom wall portion of the tablet container; and
a rotor operable to rotate about the axial line in the tablet containing space of the tablet container along with rotation of the rotary shaft, the rotor including a plurality of tablet receiving portions configured to receive the tablets one by one and allow the tablets to pass therethrough to the discharge port, and the rotor including the plurality of tablet receiving portions configured being provided in the peripheral portion so as to be aligned in the direction of rotating of the rotary shaft:
wherein the rotor includes a core member rotating with the rotary shaft and the plurality of tablet receiving portions at an outer peripheral portion, and a body member including a fitting hole fitted to the core member,
wherein retention mechanism is arranged between the core member and the body member for determining a relative position between the core member and the body member and for retaining a fixed state between the core member and the body member,
wherein the retention mechanism comprises one or more engaged hole portions provided at one of the core member and the body member and the one or more engaging protrusion portions provided at the other of the core member and the body member, the engaged hole portion including an aperture extending in a radial direction orthogonal to an axial direction of the rotary shaft and opening toward the other of the core member and the body member, and the engaging protrusion portion extending in the radial direction orthogonal to the axial direction of the rotary shaft and projecting toward the one of the core member and the body member and a tip portion of the engaging protrusion portion entering into the engaged hole portions, and
wherein structure of the engaging protrusion or structure of the core member and the body member is so configured as to cause relative movement between the core member and the body member by the tip portions of the one or more engaging protrusion portions being contact state with the other of the core member and the body member when the tip portions of the one or more engaging protrusion portions do not enter into the one or more engaged hole portions provided at the other of the core member and the body member.

2. The tablet cassette according to claim 1, wherein
the one or more engaging protrusion portions is a plurality of engaging protrusion portions,
the one or more engaged hole portions is a plurality of engaged hole portions and
the plurality of engaging protrusion portions and the plurality of engaged hole portions are respectively provided equally spaced apart.

3. The tablet cassette according to claim 1, wherein
shape and structure of the tip portion of the one or more engaging protrusion portions are determined to allow the one or more engaging protrusion portions to escape from the one or more engaged hole portions and allow the core member to rotate within the body member when the main body member is restrained in a state where the one or more engaging protrusion portions are fitted in the one or more engaged hole portions.

4. The tablet cassette according to claim 3, wherein
the engaging protrusion portion includes a rolling element, a biasing member operable to bias the rolling element so as to allow the displacement of the rolling element in the radial direction, and a containing structure containing the rolling element and the biasing member so as to expose a part of the rolling element.

5. The tablet cassette according to claim 4, wherein
the biasing member has characteristics defined so as to allow the rolling element to escape from the engaged hole portion and to allow the core member to idle in the body member when the body member is restrained in a state where the part of rolling element is fitted in the engaged hole portion.

6. The tablet cassette according to claim 5, wherein
the rolling element is a sphere, and the biasing member is an elastic element.

7. The tablet cassette according to claim 1, wherein
the engaging protrusion portion includes a stopper portion which contacts a peripheral portion of the aperture of the engaged hole portion in a state in which the tip portion is fitted in the engaged hole portion provided at the other of the core member and the body member, the stopper portion is provided around a base portion of the tip portion.

8. The tablet cassette according to claim 7, wherein
the tip portion of the engaging protrusion portion has a curved surface which is convex toward the direction of protruding.

9. The tablet cassette according to claim 1, wherein
the one or more engaged hole portions are formed at portion of the body member where the tablet receiving portions are not formed.

10. The tablet cassette according to claim 9, wherein
the one or more engaged hole portions are formed at portion of the body member where the tablet receiving portions are not formed, the engaged hole portion is a through hole penetrating the body member in the radial direction.

11. The tablet cassette according to claim 1, wherein
an RFID tag having identification information used for confirming suitability of the body member is mounted within the fitting hole of the body member.

12. The tablet cassette according to claim 2, wherein
an RFID tag having identification information used for confirming suitability of the body member is mounted within the fitting hole of the body member.
